(19) United States
(12) Patent Application Publication
(10) Pub. No.: US 2004/0086041 A1
(43) Pub. Date: May 6, 2004

(54) System and method for advanced data partitioning for robust video transmission

(75) Inventors: Jong Chul Ye, Croton-on-Hudson, NY (US); Yingwei Chen, Briarcliff Manor, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/284,217

(22) Filed: Oct. 30, 2002

(51) Int. Cl. H04N 7/12

(52) U.S. Cl. 375/240.08; 375/240; 375/240.16

(57) ABSTRACT

A system and method are disclosed that provide a single layer bit stream syntax with advanced DCT data partitioning designed to combat bit error and packet losses during transmission. The bit stream syntax may be used as a single layer bit stream or may be used to de-multiplex video packets into base and enhancement layers in order to allow unequal error protection. One advantage of this syntax is that the de-multiplexing and merging of received video packets is made simple while allowing for flexible bit allocation for the base and enhancement layers.

### BACKGROUND OF THE INVENTION

1. Field of the Invention

The present invention is related to video coding systems, in particular, the invention relates to an advanced data partition scheme that enables robust video transmission. The invention has particular utility in connection with variable-bandwidth networks and computer systems that are able to accommodate different bit rates, and hence different quality images.

2. Description of the Related Art

Scalable video coding in general refers to coding techniques that are able to provide different levels, or amounts, of data per frame of video. Currently, such techniques are used by video coding standards, such as MPEG-1 MPEG-2 and MPEG-4 (i.e., Motion Picture Experts Group), in order to provide flexibility when outputting coded video data. While MPEG-1 and MPEG-2 video compression techniques are restricted to rectangular pictures from natural video, the scope of MPEG-4 visual is much wider. MPEG-4 visual allows both natural and synthetic video to be coded and provides content based access to individual objects in a scene.

MPEG-4 encoded data streams can be described by a hierarchy. The highest syntactic structure is the visual object sequence. It consists of one or more visual objects. Each visual object belongs to one of the following object types: video object, still texture object, mesh object, face object. For example, in the video objects, a natural video object is encoded in one or more video object layers. Each layer enhances the temporal or spatial resolution of a video object. In single layer coding, only one video object layer exists.

Each video object layer contains a sequence of 2D representations of arbitrary shape at different time intervals that is referred to as a video object plane (VOP). These VOPs can be structured in groups of video object planes (GOV). Video object planes are divided further into macroblocks. To provide access to an individual video object, MPEG-4 encodes a representation of its shape in addition to encoding motion and texture information.

The MPEG-4 video standard applies well known compression tools. Spatial correlation is removed by using a discrete cosine transform (DCT) followed by a visually weighted quantization. Block based motion compensation is applied to reduce temporal redundancies. MPEG-4 employs three different types of video object planes, namely, intra-coded (I), predictive-coded (P) and bidirectionally predictive coded (B) VOPs.

To further reduce the bitrate, predictors are used while coding the results from the spatial and temporal redundancy reduction steps. Predictive coding is employed to encode the DC coefficient and some of the AC coefficients in intra-coded blocks. Additionally, motion vectors and shape information are encoded differentially. The extensive use of predictive coding results in strong dependencies between neighboring macroblocks, i.e. a macroblock can only be decoded if the information of a certain number of preceding macroblocks is available.

To avoid long chains of interdependent macroblocks, MPEG-4 creates self-containing video packets (VP) comparable to the group of blocks (GOB) structure in H.261/H.263 and the definition of slices in MPEG-1/MPEG-2. MPEG-4 video packets are based on the number of bits contained in a packet and not on the number of macroblocks. If the size of the currently encoded video packet exceeds a certain threshold, the encoder will start a new video packet at the next macroblock.

As shown in FIG. 1, the MPEG-4 video packet structure includes a RESYNC marker, a quantization paramerter (QP), a header extension code (HEC), a macroblock (MB) number, motion and header information, a motion marker (MM) and texture information. The MB number provides the necessary spatial resynchronization while the quantization parameter allows the differential decoding process to be resynchronized.

The motion and header information field includes information of motion vectors (MV) DCT DC coefficients, and other header information such a macroblock types. The remaining DCT AC coefficients are coded in the texture information field. The motion marker separates the DC and AC DCT coefficients.

The MPEG-4 video standard provides error robustness and resilience to allow accessing image or video information over a wide range of storage and transmission media. The error resilience tools developed for the MPEG-4 video standard can be divided into three major areas: resynchronization, data recovery, and error concealment.

The resynchronization tools attempt to enable resynchronization between a decoder and a bitstream after a residual error or errors have been detected. Generally, the data between the synchronization point prior to the error and the first point where synchronization is reestablished, is discarded. If the resynchronization approach is effective at localizing the amount of data discarded by the decoder, then the ability of other types of tools that recover data and/or conceal the effects of errors is greatly enhanced.

The current video packet approach used by MPEG-4 is based on providing periodic resynchronization markers throughout the bitstream. The length of the video packets are not based on the number of macroblocks, but instead on the number of bits contained in that packet. If the number of bits contained in the current video packet exceeds a predetermined threshold, then a new video packet is created at the start of the next macroblock.

The resynchronization (RESYNC) marker is used to distinguish the start of a new video packet. This marker is distinguishable from all possible VLC codewords as well as the VOP start code. Header information is also provided at the start of a video packet. Contained in this header is the information necessary to restart the decoding process.

After synchronization has been reestablished, data recovery tools attempt to recover data that in general would be lost. These tools are not simply error correcting codes, but instead techniques that encode the data in an error resilient manner. For example, one particular tool is Reversible Variable Length Codes (RVLC). In this approach, the variable length codewords are designed such that they can be read both in the forward as well as the reverse direction.

An example illustrating the use of a RVLC is given in FIG. 2. Generally, in a situation such as this, where a burst of errors has corrupted a portion of the data, all data between the two synchronization points would be lost. However, as shown in FIG. 2, an RVLC enables some of that data to be recovered.

However, there exists a need for a video coding technique that incorporates improved data partitioning for robust video transmission.

### SUMMARY OF THE INVENTION

The present invention addresses the foregoing need by allowing flexible allocation of the DCT AC information before and after the motion marker (MM) in the conventional video packet structure. This is facilitated by adding priority break point information within the video packet structure.

One aspect of the present invention is directed to a system and method that provide a single layer bit stream syntax with advanced DCT data partitioning designed to combat bit error and packet losses during transmission. The bit stream syntax may be used as a single layer bit stream or may be used to de-multiplex video packets into base and enhancement layers in order to allow unequal error protection.

One advantage of this syntax is that the de-multiplexing and merging of received video packets is made simple while allowing for flexible bit allocation for the base and enhancement layers.

Another aspect of the present invention, the priority break point also allows for the use of RVLC to combat bit errors.

Yet another aspect of the present invention, due to the resynchronization marker and the priority break point, the video packet structure of the present invention is also capable of combating video packet losses.

One embodiment of the present invention is directed to a coded video packet structure that includes a resynchronization marker that indicates a start of the coded video packet structure, a priority break point (PBP) value and a motion/texture portion including DC DCT coefficients and a first set of AC DCT coefficients. The first set of AC DCT coefficients are included in the motion/texture portion in accordance with the priority break point value. The video packet structure also includes a texture portion that includes a second set of AC DCT coefficients different than the first set of AC DCT coefficients, and a motion marker separating the motion/texture portion and the texture portion.

Another embodiment of the present invention is directed to a method of encoding video data including the steps of receiving input video data, determining DC and AC DCT coefficients for the uuencoded video data and formatting the DC and AC coefficients into a coded video packet. The coded video packet including a start marker, a first subsection including the DC and a portion of the AC DCT coefficients, a second subsection including a second portion of the AC DCT coefficients not included in the first subsection and a separation marker between the first and second subsections. The method also includes the steps of separating the video packet to form a first layer including the first subsection and a second layer including the second subsection in accordance with the separation marker.

Yet another embodiment of the present invention is directed to an apparatus for merging a base layer and at least one enhancement layer to form a coded video packet. The apparatus includes a memory which stores computer-executable process steps and a processor which executes the process steps stored in the memory so as (i) to receive the base layer that includes both DC and AC DCT coefficients and the enhancement layer, (ii) to search for a motion marker in the enhancement layer, (iii) to combine the base layer and the enhancement layers after stripping off the enhancement layer packet header. A PBP value provides an indication as to the range of AC DCT coefficients included in the base layer.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

FIG. 1 depicts a conventional MPEG-4 video packet structures.

FIG. 2 depicts a conventional example of Reversible Variable Length Coding.

FIG. 3 depicts a video packet structure in accordance with a preferred embodiment of the present invention.

FIG. 4 depicts a video coding system in accordance with one aspect of the present invention.

FIG. 5 depicts a functional block diagram of a splitting/merging operation in accordance with a preferred embodiment of the present invention.

FIG. 6 depicts a computer system on which the present invention may be implemented.

FIG. 7 depicts the architecture of a personal computer in the computer system shown in FIG. 4.

FIG. 8 is a flow diagram describing one embodiment of the present invention.

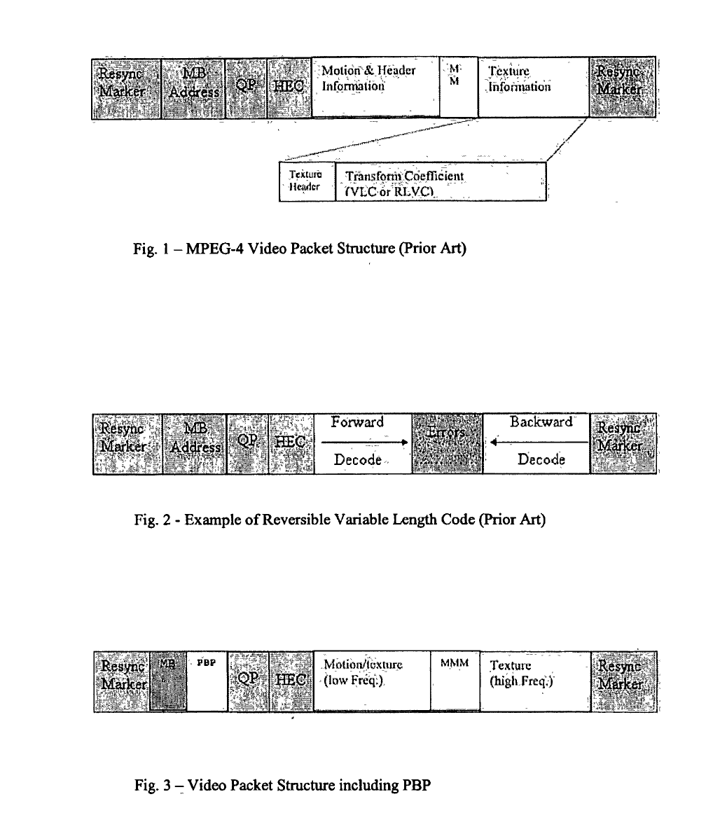

### DETAILED DESCRIPTION OF THE PREFERRED EMBODIMENTS

Referring now to FIG. 3, a video packet (VP) structure is shown including a priority break point (PBP). The REYNC marker, MP number, QP and HEC elements shown in FIG. 3 are the same as shown in FIG. 1. However, the motion marker (MM) of FIG. 1 is now a movable motion marker (MMM). The PBP allows for the flexible allocation of the DCT AC information before and after the MMM by signaling the PBP of the DCT AC coefficients. Since there is a maximum of 64 run-length pairs for each DCT block, the PBP value can be encoded with 6 bits fixed length code.

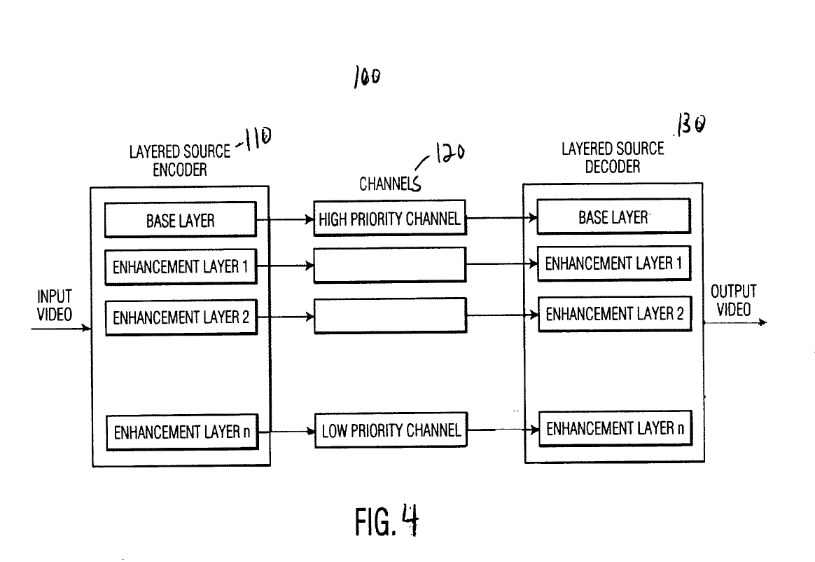

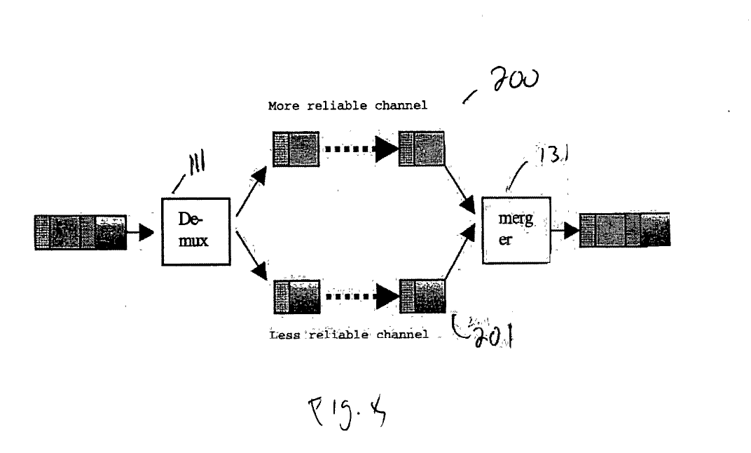

An advantage of the VP as shown in FIG. 3 will be discussed in conjunction with FIG. 4. FIG. 4 illustrates a video system 100 with layered coding and transport prioritization. A layered source encoder 110 encodes input video data. A plurality of channels 120 carry the encoded data. A layered source decoder 130 decodes the encoded data.

There are different ways of implementing layered coding. For example, in temporal domain layered coding, the base layer contains a bit stream with a lower frame rate and the enhancement layers contain incremental information to obtain an output with higher frame rates. In spatial domain layered coding, the base layer codes the sub-sampled version of the original video sequence and the enhancement layers contain additional information for obtaining higher spatial resolution at the decoder.

Generally, a different layer uses a different data stream and has distinctly different tolerances to channel errors. To combat channel errors, layered coding is usually combined with transport prioritization so that the base layer is delivered with a higher degree of error protection. If the base layer is lost, the data contained in the enhancement layers may be useless.

One advantage of the VP structure shown in FIG. 3 is that it allows splitting video packets into Base and Enhancement layers by just searching for the MMM within each VP. This is described in greater detail below.

In addition, the VP structure of FIG. 3 allows for flexible control of the minimal Base layer (BL) video quality. The desired BL can be controlled by selecting the PBP accordingly. The video system 100 may have one or more preprogrammed default PBP based upon different criteria and/or user selectable PBPs. The PBP selection criteria may be based upon, for example:

(1) the number of transmission channels 120 currently available;

(2) the type/quality of transmission channels 120 currently available;

(3) the reliability of the transmission channels 120 currently available; or

(4) a user preference for BL video quality.

The value of the PBP may also be dynamically controlled based upon changes in the selection criteria and/or feedback received from a receiving end. For example, if a VP is lost and/or corrupted with errors, the PBP can be dynamically changed to increase/decrease the BL video quality in response to these changes. Increasing the video quality of the BL will ensure that the decoded information at a receiving end will at least of a predetermined video quality even if one or more enhancement layers is lost.

A block diagram of Base (BL) and Enhancement (EL) layer splitting is shown in FIG. 5. At a transmitting end, a demultiplexer 111, which may be part of the layered source encoder 110 shown in FIG. 4, separates the VP, as shown in FIG. 3, into a base layer 200 and one or more enhancement layers 201 (only one enhancement layer 201 is shown in FIG. 5). At a receiving end, a merger 131, which may be part of the layered source decoder 130, mergers the base layer 200 and the one or more enhancement layers 201.

The search operation of the movable motion marker (MMM) incurs minimal computational overhead since the MMM is unique and there is no MMM emulation from other data such as the DCT AC coefficients. This allows for the design of the demultiplexer 111 and the merger 131 to be easily and inexpensively designed in hardware or software as compared to conventional Base and Enhancement layer encoders/decoders.

In the merger, when the Base and Enhancement layers are to be combine, the merger simply needs to locate the MMM, stripping off the enhancement layer packet header and add the MMM and texture information to the Base layer. The Base and Enhancement layers can thus be combined to reform the video packet structure as shown in FIG. 3. The PBP is used to indicated to the merger 131 (or the decoder) which portion of the AC DCT coefficients were included in the Base layer.

In addition, by transmitting the PBP value and the corresponding low frequency DCT coefficients (i.e., DC and some AC DCT coefficients) over a more reliable transmission channel, greater dynamic allocation of the DCT information is achievable. This allows for more control of the minimal quality of the video in case one or more of the Enhancement VPs are lost. In this regard, the conventional MPEG-4 VP shown in FIG. 1 can only split the DC DCT information from the remaining AC DCT information which only allows for minimal control of the video quality in the Base layer.

It is noted that even without splitting the VPs as shown in FIG. 5, the single layer syntax can be useful by combating bit errors as well as packet losses. In this regard, if there are bit errors after MMM, the DCT DC and low frequency DCT AC components can be still decodable and used to provide a minimal video quality. The minimal video quality can be controlled by adjusting the PBP value. The only overhead of this interoperability of the present invention into a single or dual layer is the bit overhead by introducing a new field (i.e., the PBP) into the VP structure. However as discussed above this is only a few bits (e.g., 6 bits) which is negligible considering the normal size of the VPs (about several hundred bytes).

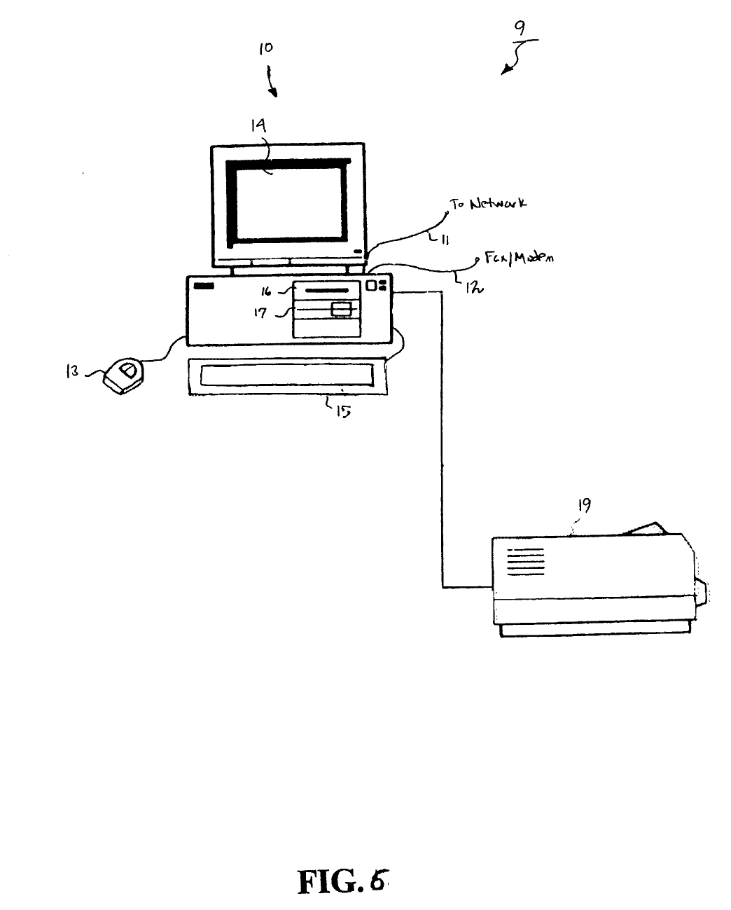

FIG. 6 shows a representative embodiment of a computer system 9 on which the present invention may be implemented. As shown in FIG. 6, personal computer (“PC”) 10 includes network connection 11 for interfacing to a network, such as a variable-bandwidth network or the Internet, and fax/modem connection 12 for interfacing with other remote sources such as a video camera (not shown). PC 10 also includes display screen 14 for displaying information (including video data) to a user, keyboard 15 for inputting text and user commands, mouse 13 for positioning a cursor on display screen 14 and for inputting user commands, disk drive 16 for reading from and writing to floppy disks installed therein, and CD-ROM drive 17 for accessing information stored on CD-ROM. PC 10 may also have one or more peripheral devices attached thereto, such as a scanner (not shown) for inputting document text images, graphics images, or the like, and printer 19 for outputting images, text, or the like.

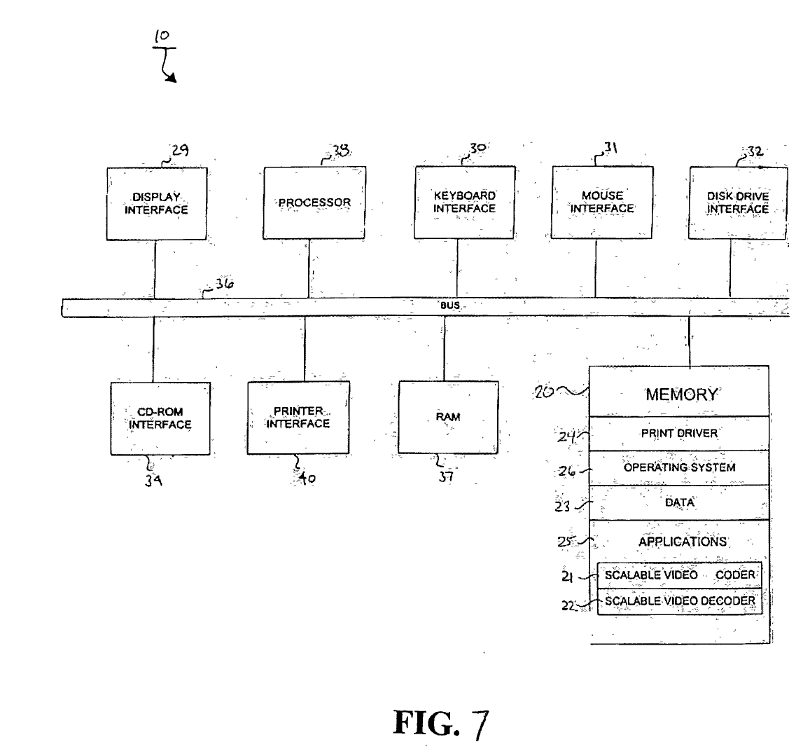

FIG. 7 shows the internal structure of PC 10. As shown in FIG. 7, PC 10 includes memory 20, which comprises a computer-readable medium such as a computer hard disk. Memory 20 stores data 23, applications 25, print driver 24, and operating system 26. In preferred embodiments of the invention, operating system 26 is a windowing operating system, such as Microsoft Windows95; although the invention may be used with other operating systems as well. Among the applications stored in memory 20 are scalable video coder 21 and scalable video decoder 22. Scalable video coder 21 performs scalable video data encoding in the manner set forth in detail below, and scalable video decoder 22 decodes video data, which has been coded in the manner prescribed by scalable video coder 21. The operation of these applications is described in detail below.

Also included in PC 10 are display interface 29, keyboard interface 30, mouse interface 31, disk drive interface 32, CD-ROM drive interface 34, computer bus 36, RAM 37, processor 38, and printer interface 40. Processor 38 preferably comprises a microprocessor or the like for executing applications, such those noted above, out of RAM 37. Such applications, including scalable video coder 21 and scalable video decoder 22, may be stored in memory 20 (as noted above) or, alternatively, on a floppy disk in disk drive 16 or a CD-ROM in CD-ROM drive 17. Processor 38 accesses applications (or other data) stored on a floppy disk via disk drive interface 32 and accesses applications (or other data) stored on a CD-ROM via CD-ROM drive interface 34.

Application execution and other tasks of PC 4 may be initiated using keyboard 15 or mouse 13, commands from which are transmitted to processor 38 via keyboard interface 30 and mouse interface 31, respectively. Output results from applications running on PC 10 may be processed by display interface 29 and then displayed to a user on display 14 or, alternatively, output via network connection 11. For example, input video data that has been coded by scalable video coder 21 is typically output via network connection 11. On the other hand, coded video data that has been received from, e.g., a variable bandwidth-network is decoded by scalable video decoder 22 and then displayed on display 14. To this end, display interface 29 preferably comprises a display processor for forming video images based on decoded video data provided by processor 38 over computer bus 36, and for outputting those images to display 14. Output results from other applications, such as word processing programs, running on PC 10 may be provided to printer 19 via printer interface 40. Processor 38 executes print driver 24 so as to perform appropriate formatting of such print jobs prior to their transmission to printer 19.

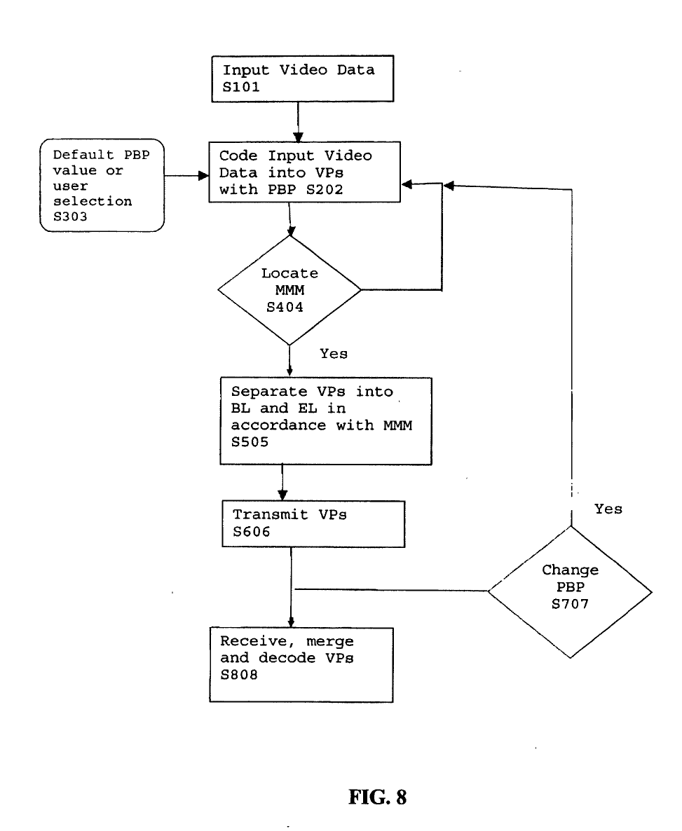

FIG. 8 is a flow diagram that explains the functionality of the video system 100 shown in FIG. 4. To begin, in step S101 original uncoded video data is input into the video system 100. This video data may be input via network connection 11, fax/modem connection 12, or via a video source. For the purposes of the present invention, the video source can comprise any type of video capturing device, an example of which is a digital video camera.

Next, step S202 codes the original video data using a standard technique. The layered source encoder 111 may perform step S202. In preferred embodiments of the invention, the layered source encoder 111 is an MPEG-4 encoder. In step S303, a default or user-selected PBP value is used during the code step S202. The resulting VP has a structure as shown FIG. 3.

In step S404, the MMM is located. The VP is then split into Base and Enhancement layers in step S505. The Base and Enhancement layers are then transmitted, in step S606. Preferably BL is transmitted using the most reliable and/or highest priority channel available.

Optionally, in step s707, various transmission parameters and channel data can be monitored, e.g., in a streaming video application. This allows the PBP to be dynamically changed in accordance with changes during transmission.

The VPs are received by a decoder, e.g., the layered source decoder 130, merged and decoded in step S808.

Although the embodiments of the invention described herein are preferably implemented as computer code, all or some of the step shown in FIG. 8 can be implemented using discrete hardware elements and/or logic circuits. Also, while the encoding and decoding techniques of the present invention have been described in a PC environment, these techniques can be used in any type of video devices including, but not limited to, digital televisions/settop boxes, video conferencing equipment, and the like.

In this regard, the present invention has been described with respect to particular illustrative embodiments. It is to be understood that the invention is not limited to the above-described embodiments and modifications thereto, and that various changes and modifications may be made by those of ordinary skill in the art without departing from the spirit and scope of the appended claims.

What is claimed is:

1. A coded video packet structure, comprising:
a resynchronization marker that indicates a start of the coded video packet structure;
a priority break point (PBP) value;
a motion/texture portion including DC DCT coefficients and a first set of AC DCT coefficients, the first set of AC DCT coefficients being included in the motion/texture portion in accordance with the priority break point value;
a texture portion including a second set of AC DCT coefficients different than the first set of AC DCT coefficients; and
a motion marker separating the motion/texture portion and the texture portion.

2. The video packet structure according to claim 1 wherein the first set of AC DCT coefficients include a first range of AC DCT coefficients starting from a first non-DC DCT coefficient to an upper limit selected in accordance with the PBP value.

3. The video packet structure according to claim 2 wherein the second set of AC DCT coefficients that are above the upper limit.

4. A demultiplexer arranged to separate the coded video packet structure in accordance with claim 1 into a base layer and one or more enhancement layers in accordance with the motion marker.

5. The demultiplexer according to claim 4 wherein the demultiplexer is part of a layered source encoder.

6. The demultiplexer according to claim 5 wherein the layered source encoder is an MPEG-4 encoder.

7. A merger arranged to merge the base layer and the one or more enhancement layers separated in accordance with claim 4.

8. The merger according to claim 4 wherein the merger is part of a layered source decoder.

9. The merger according to claim 8 wherein the layered source decoder is an MPEG-4 decoder.

10. A method of encoding video data comprising the steps of:
receiving input video data;
determining DC and AC DCT coefficients for the uncoded video data;
formatting the DC and AC coefficients into a coded video packet, the coded video packet including a start marker, a first subsection including the DC and a portion of the AC DCT coefficients, a second subsection including a second portion of the AC DCT coefficients not included in the first subsection and a separation marker between the first and second subsections; and
separating the video packet to form a first layer including the first subsection and a second layer including the second subsection in accordance with the separation marker.

11. The method according to claim 10 further comprising the step of transmitting the first and second layers over different transmission channels.

12. The method according to claim 10 wherein the formatting step includes using a priority break point value to determine the portion of the AC DCT coefficients to include in the first subsection.

13. The method according to claim 10 wherein the priority break point value is based upon predetermined selection criteria or user specified.

14. The method according to claim 13 wherein the priority break point value may be changed during encoding of subsequent input video data in accordance with changes in the predetermined selection criteria.

15. An apparatus for merging a base layer and at least one enhancement layer to form a coded video packet, the apparatus comprising:
a memory which stores computer-executable process steps; and
a processor which executes the process steps stored in the memory so as (i) to receive the base layer that includes both DC and AC DCT coefficients and the enhancement layer, (ii) to search for a marker in the enhancement layer, (iii) to combine the base layer and the enhancement layers in accordance with the marker,
wherein a header value provides an indication as to a range of AC DCT coefficients included in the base layer.

16. An apparatus according to claim 15 wherein the header value is a priority break pointer and the marker is a motion marker.

17. An apparatus according to claim 15 further comprises means for decoding the coded video packet.
